(19) United States
(12) Patent Application Publication
(10) Pub. No.: US 2014/0172313 A1
(43) Pub. Date: Jun. 19, 2014

(54) HEALTH, LIFESTYLE AND FITNESS MANAGEMENT SYSTEM

(71) Applicant: Gary Rayner, San Diego, CA (US)

(72) Inventor: Gary Rayner, San Diego, CA (US)

(21) Appl. No.: 14/040,514

(22) Filed: Sep. 27, 2013

Related U.S. Application Data
(60) Provisional application No. 61/706,626, filed on Sep. 27, 2012.

(51) Int. Cl. G06F 19/00

(52) U.S. Cl. CPC G06F 19/3431
USPC 702/19

(57) ABSTRACT

Devices, methods, and systems for modulating a user's personal health are presented. In one aspect, a device containing a sensor is configured for tracking, measuring, and modulating a characteristic is provided. In certain instances, the characteristic to be measured pertains to food consumption. A personal health modulating device for communicating health modulating data with a mobile computing device is presented. The mobile computing device includes at least one electronic data input for receiving electronic data, at least one wireless transceiver for communicating with a wireless network, and an interactive display. The personal health modulating device includes a wearable unit configured to be worn on a part of a user's body, the wearable unit having one or more sensors to sense an environment of the user, to gather data representing one or more attributes related to an activity of a user within the environment, the data being selected for processing according to one or more personal health modulating data processing routines, the wearable unit further having a transmitter to transmit the data to the at least one electronic data input of the mobile computing device.

### CROSS-REFERENCE TO RELATED APPLICATIONS

This application claims priority from U.S. Provisional Application No. 61/706,626, with a filing date of Sep. 27, 2012. The disclosure of which cited in this paragraph is hereby incorporated herein by reference in its entirety.

### FIELD OF THE DISCLOSURE

The following disclosure relates to health, lifestyle, and fitness management.

### BACKGROUND

Obesity is a prolific problem. The proportion of obese adults and children is dramatically increasing Worldwide. Being Obese is especially problematic in that it increases the risk of contracting heart disease, stroke, type 2 diabetes, and cancer, as well as other various types of Obesity-related health conditions that, in many circumstances, could otherwise be preventable death.

Exacerbating these attendant problems is the ever-increasing rise of medical costs associated with obesity; medical costs that are significantly higher for those suffering from obesity than those not suffering therefrom. Projections estimate that a majority of the population can soon be suffering from obesity associated maladies, with a significant portion of those so suffering being severely obese, if a change in the population's eating habits does not occur. Health experts fear an even more dramatic jump in health care costs will ensue if nothing is done to bring obesity under control.

Currently, there are several weight-control strategies being employed in an attempt to curb or at least ameliorate obesity prior to the onset of its associated problems. Specifically, these weight-control strategies can be divided into four separate categories: (1) mental state modulation, (2) eating reduction, (3) exercising, and (4) sleep. For instance, in an effort to curb obesity many people join weight control groups and/or try to lose weight by attempting to follow various different diets, such as low calorie diets, low fat diets, low carbohydrate diets. Others engage strategies designed to highly regulate their food intake that include such tasks as keeping close track of all food consumed, counting calories, as well as the types and amounts of carbs and/or fat grams consumed. Many of these components include some form of psychological counseling so as to enhance the participant's efforts in these regards.

In fact, several commercial weight-loss programs exist so as to help its members to track and control food intake. For some, exercise is a key component to controlling body weight. Many regularly exercise, for instance, by walking, running, swimming, cycling, or the like for a periodic time during the day. Others attempt to modulate the types of food they eat so as to better facilitate their ability to maintain a healthy diet. For example, many eat breakfast regularly, often including whole grains and low-fat dairy products, or eat a variety of colored foods or simply eat similar foods regularly without splurging. Others limit dining out or fast food consumption. Some limit the amount of TV they watch or at least increase the activities they do while watching TV. In many such instances, the would-be dieter often engages in routinely weighing themselves.

Additionally, there are many various products on the market that aid the dieter in monitoring his or her weight-control strategies. For example, there are diet pills, diet drinks and shakes, on-line diet support groups, as well as exercise videos. Additionally, there are systems and methods for tracking daily steps, stairs climbed, distance walked, calories burned, and heart rate. However, although weight-loss groups have been effective for some, most people attempting to diet end up re-gaining at least a portion if not all of the weight they have lost during a dieting or exercise regime once that particular regimen has ended. And although tracking food intake and regulating the types of foods as well as the quantity eaten can be helpful, such tasks our onerous and time consuming to maintain. Furthermore, many of the dieting supplements and exercise products on the market lack effectiveness simply do to low compliance and maintained follow through.

Accordingly, there is a need for a weight-control system that overcomes these and other such problems, such as a system that can monitor one or a multiplicity of the above referenced categories, for instance, in real time, while providing contemporaneous counseling and/or coaching in a manner the alleviates the onerous tasks of personally tracking and monitoring food consumption. The devices, methods, and systems of this present disclosure aim at meeting these and other related needs, while maximizing the individual's ability to control one's ideal weight and to maintain that weight over a prolonged period of time.

### SUMMARY OF THE DISCLOSURE

The present disclosure, in its many aspects, describes devices, methods, and systems for enhancing one's ability to modulate, achieve, and maintain one's desired weight, and in some instances, provides an increased fortification from contracting disease, such as obesity related diseases exemplified, but not limited here by: heart disease, stroke, type 2 diabetes, and cancer, as well as other various types of obesity-related health conditions. In one aspect, a device containing a sensor that is configured for tracking, measuring, and modulating a characteristic is provided. In certain instances, the characteristic to be measured pertains to food consumption, such as the food consumption of a subject individual in need of tracking, measuring, or modulating, and the device containing the sensor and performing the measurement is configured as an eating instrument, such as a utensil, bowl, dish, cup, pot, pan, or the like. In such an instance, the individual sensor may be an optical, electromagnetic, magnetic, mechanical sensor, or other suitable sensor configured for determining a characteristic related to the consumption of a food item. For instance, in some embodiments, the sensor is a strain gauge or scale capable of measuring and recording the weight change of a sample of food during the consumption process.

In one particular aspect, a personal health modulating system includes a mobile computing device comprising at least one electronic data input for receiving electronic data, at least one wireless transceiver for communicating with a wireless network, and an interactive display. The system further includes at least one sensor to sense an environment that is external to the mobile computing device, to gather data representing one or more attributes related to an activity of a user, and to transmit the data to the at least one electronic data input of the mobile computing device. The system further includes an internal processor that is internal to the mobile computing device, the internal processor executing an application to receive, via the at least one electronic data input, the data representing the one or more attributes related to the activity, to process the data according to one or more personal health modulating data processing routines, and to generate a graphical user interface for display on the interactive display of the mobile computing device, the graphical user interface providing a representation of at least one of the one or more personal health modulating data processing routines.

In another aspect, a personal health modulating method includes the steps of receiving, by at least one electronic data input of a mobile computing device, data representing one or more attributes related to an activity of a user, the data being sensed and gathered from an environment that is external to the mobile computing device by at least one sensor, the mobile computing device further comprising, at least one wireless transceiver for communicating with a wireless network, an interactive display, and an internal processor. The method further includes the steps of receiving, by the internal processor of the mobile computing device, the data representing the one or more attributes related to the activity, and processing, by the internal processor of the mobile computing device, the data according to one or more personal health modulating data processing routines. The method further includes the step of generating a graphical user interface for display on the interactive display of the mobile computing device, the graphical user interface providing a representation of at least one of the one or more personal health modulating data processing routines.

In yet another aspect, a personal health modulating device for communicating health modulating data with a mobile computing device is disclosed. The mobile computing device has at least one electronic data input for receiving electronic data, at least one wireless transceiver for communicating with a wireless network, and an interactive display. The personal health modulating device includes a wearable unit configured to be worn on a part of a user's body, the wearable unit having one or more sensors to sense an environment of the user, to gather data representing one or more attributes related to an activity of a user within the environment, the data being selected for processing according to one or more personal health modulating data processing routines. The wearable unit further includes a transmitter to transmit the data to the at least one electronic data input of the mobile computing device.

In certain other instances, the characteristic to be measured pertains to a characteristic indicative of a quality of sleep, and the device containing the sensor is a wristband or watch, specifically designed to monitor, record, and observe the motion of the arms of the body during a time leading up to and through sleep. In such an instance, the sensor may include one or more of a GPS, an accelerometer, a gyroscope, a time measuring device, e.g., a clock, a timer, or a stopwatch, and the like. In some additional instances, the characteristic to be measured is a physiological characteristic, such as heart rate, a blood pressure, an oxygen, carbon dioxide, and/or nitrogen level in the blood, and the sensor device for measuring the characteristic may be an oximeter or other device capable of sensing and/or measuring the presence and/or concentration of oxygen, carbon dioxide, carbon monoxide, and/or the like, in the blood.

In certain other instances of the disclosure the characteristic to be measured is an exertion level appurtenant to an amount of exercise activity to be or currently being engaged in, and the sensor portion of the device designed to measure the activity includes a GPS, a distance measuring device, e.g., a pedometer, a time measuring device, e.g., a clock, a timer, or a stopwatch, and the like, an accelerometer, a gyroscope, a scale, a strain gauge, and the like.

In one aspect, a method is provided wherein the method includes one or more of several steps related to the tracking, measuring, and modulating of a characteristic, such as a characteristic pertaining to one or more of food consumption, a sleep condition, an exertion based performance level, and/or one or more physiological conditions. In particular, the method may include one or more steps involving the sensing and/or measuring of the condition, the monitoring and/or tracking of the condition, which may or may not include the comparison of the measured condition to an ideal condition, and the generation of a recommendation for a behavioral change influencing the condition so as to modulate the condition in a manner that leads to better food consumption, better quality of sleep, better performance with respect to an activity to be engaged in, and/or better physiological conditions as well as better overall health.

In certain instances, the method may also include the computer based generation of data, such as sensed data that is captured within the memory of a database, the wire or wireless based transmission and/or reception of that data, such as at a centralized processing unit, and the performance of an analysis of the data so as to generate one or more instructions or recommendations pertaining to how the activities that led to the generation of the data in the first instance may be modulated so as to change a predetermined characteristic resulting from the modulated activities. In various embodiments, the capturing of the data in the first instance may include employing one or more sensors to sense a data characteristic, such as that which results from an action, e.g., by using a camera or recorder to capture and/or record the data; and the transmission of the data to a centralized analysis hub may include the engagement of a wired or wireless transmission protocol that is adapted for the transmission of that data from one location to another, such as electronically. In certain instances, the transmission step may be preceded by a conversion step where the photo, video, and/or sound recorded data is converted from one from to another, such as from a still or analog form to a digital from, for instance, prior to transmitting that transformed data from one location to another.

Further, the analysis step may include one or both of computer based analysis and/or human conducted analysis, such as involving the comparing of generated data to a database, e.g., an electronic database stored in an electronic memory, or an image based database retrievable and/or viewable by hand by an individual; and may further include the step of determining the characteristics leading to the observed data set and/or the generation of a set of instructions or recommendations as to how to modulate the base conditions so as to change the characteristics leading to the sensed data in the first instance. In certain instances, the method may include performing one or more statistical analysis functions on the data, e.g., in comparison to a sample or sample set of ideal data points so as to generate a weighted average in support of the recommended instructions to be generated and transmitted back, e.g., to the user or other interested third party, in response to the analyzed data.

In various embodiments, the methods may include the transmission of the generated instructions and/or recommendations to the user so as to effectuate, or at least encourage the effectuation of a behavioral change of the actions that first lead to the generation of the data in the first instance. For instance, the method may include providing coaching to the user generating the data so as to change the user's behaviors with respect to the activities that were coincident with the generation of the data set in the first instance so as to modulate the conditions precedent. The coaching or other feedback may be transmitted back to the user in any manner sufficient to draw the attention of the user to the feedback and promote a change or reaffirmation of an activity.

Accordingly, in certain aspects, the disclosure is directed to software including machine executable instruction sets, machine readable media containing the machine executable instruction sets, and hardware, such as microprocessor chips, configured for storing and executing the machine readable instructions in accordance with a variety of conditions precedent. Accordingly, in certain aspects, the disclosure is directed to a system for tracking, measuring, and modulating a characteristic, such as a characteristic pertaining to one or more of food consumption, a sleep condition, an exertion based performance level, and/or one or more physiological conditions. In certain instances, the system may include one or more health-modulating sensing devices; one or more remote computing devices, such as for receiving, processing, and/or transmitting data from one interface to another; and/or one or more centralized processing units, such as containing one or more computer or human processing actors, which actors are capable of performing one or more operations on a received data set so as to generate a recommended instruction protocol.

Hence, in view of the above, the weight tracking and modulating devices, methods, and systems herein disclosed are designed to work together so as to track, monitor, and/or modulate one or more of food consumption, sleep conditions, physical exertion parameters, as well as physiological conditions while, in certain instances, providing real time feedback and coaching to the user, who then may use that coaching to modulate his or her activities in response thereto. The health-modulating devices, herein described, are easy to use, the methods simple to follow, and the systems formulated to ensure maximum efficacy in achieving one's dietary, exercise, and overall health goals.

Accordingly, in one embodiment, a management system is provided. In various embodiments, the management system is a personal management system. In certain instances, the personal management system may include one or more of a computing device, such as a computing device that includes an internal processor, and/or a sensing device. Hence, in one particular instance, the personal management system includes at least a first computing device, such as a mobile computing device, for instance, a computing device that includes at least one electronic data input mechanism for receiving data, e.g., electronic data. The computing device may also include one or more of a processor, such as a processor internal or external to the computing device, and at least one wireless transceiver, such as for communicating with a wireless network; and in certain embodiments, the computing device may additionally include a display, such as an interactive touch screen display.

In various embodiments, the personal management system may include at least one sensor so as to sense an environment that is external to the mobile computing device. In certain instances, the sensor is configured for gathering data, such as data representing one or more attributes related to an activity of a user. For instance, in certain embodiments, the sensor may be a scale and/or strain gauge, capable of fitting under a dish or bowl or glass and functioning to weigh a particular quantity of a food when said food is placed on the dishware containing the food item.

Additionally, or alternatively, in certain embodiments, the at least one sensor may be a machine-readable code reader, such as a code reader, for instance, a barcode scanner, that is configured to read a code associated with a package of food for consumption by the user. In other embodiments, the at least one sensor maybe a camera, for instance, a camera that is configured for acquiring images, e.g., digital and/or non-digital images, such as non-digital images of food, e.g., food earmarked for consumption by the user. In such an instance, the camera may or may not be integrated with the mobile computing device, and/or may be external to the mobile computing device. In some embodiments, the sensor may be adapted for transmitting generated data to a computing device, such as the aforementioned computing device, e.g., via the at least one electronic data input of the mobile computing device. In certain instances, the at least one sensor is a sleep or activity sensor to be worn on or near the user and employed for the purpose of measuring sleep and/or athletic activity patterns of the user. In various particular embodiments, the sleep and/or activity sensor may be integrated within a band, such as a wrist band, for instance, the wrist band of a watch. In some embodiments, the sensor may be a sensor configured for detecting, measuring, and/or monitoring a physiological condition of the user.

Further, in certain embodiments, the internal processor that may be internal to the mobile computing device, may be configured for executing applications, such as an application to receive, e.g., via the at least one electronic data input, data representing the one or more attributes related to the activity of the user that is to be sensed by the sensor and/or analyzed, e.g., by the computing device. In one particular instance, the processor may be configured so as to process the data, e.g., according to one or more personal management data processing protocols and/or routines, and to generate a display, such as a graphical user interface display, for displaying on the interactive display of the mobile computing device, the graphical user interface providing a representation of the at least one of the one or more personal management data processing routines. In various instances, the application, as referenced above to be executed on the internal processor is configured to transmit, via the wireless network by the at least one wireless transceiver of the mobile computing device, the data processed according to the one or more personal management data processing routines to an analyst machine connected with the network, wherein an analysis, such as a comparative and/or statistical analysis may take place so as to generate an output, such as a recommendation, as described above.

In a further aspect, a method for managing one or more attributes or characteristics, such as personal attributes, is provided. The method involves the use of a device that includes one or both of a sensing device and/or a computing device. In a particular embodiment, the method may include one or more of sensing data, such as data that may be sensed and/or gathered from an environment that is external to the computing device, and may further include receiving such data, such as by at least one electronic data input device of the computing device. The data received may represent one or more attributes related to an activity of a user. In certain instances, the computing device, e.g., mobile computing device, may further include one or more of: at least one wireless transceiver, for communicating with a wireless network; an interactive display, e.g., an interactive, touch screen display, and an internal processor. The method may further include one or more of receiving, e.g., by the internal processor of the computing device, the data representing the one or more attributes related to the activity; and/or processing, e.g., by the internal processor of the computing device, the data, such as in accordance with one or more personal management data processing routines. In some particular embodiments, the method may also include generating user interface, such as a graphical user interface, for display on the interactive display of the computing device. In such an instance, the graphical user interface may provide a representation of at least one of the one or more personal management data processing routines.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a schematic representation of the present disclosure;

FIGS. 2A-2F are schematic representations of the present disclosure;

### DETAILED DESCRIPTION

In the following paragraphs, the present devices, methods, and systems will be described in detail by way of example with reference to the drawings. Throughout this description, the various aspects and examples shown should be considered as exemplary, rather than as limitations on the present implementations. As used herein, the “embodiment” and the “present instance” refer to any one of the embodiments of the disclosure described herein, and any equivalents. Furthermore, reference to various feature(s) of the present disclosure throughout this document does not mean that all claimed embodiments must include the referenced feature(s) as these features may be mixed or matched in any logical manifestation dependent upon the particular embodiment being employed.

The present disclosure, in its many aspects, describes devices, methods, and systems for enhancing one's ability to modulate, achieve, and maintain one's desired weight, and in some instances, provides an increased fortification from contracting disease, such as obesity related diseases exemplified, but not limited here by: heart disease, stroke, type 2 diabetes, and cancer, as well as other various types of obesity-related health conditions. The weight tracking and modulating devices, methods, and systems herein disclosed are designed to work together so as to track and modulate food consumption, while, in certain instances, providing real time feedback and coaching to the user, who then may use that coaching to modulate his or her eating process in response thereto. The health-modulating devices, herein described, are easy to use, the methods simple to follow, and the systems formulated to ensure maximum efficacy in achieving one's dietary, exercise, and overall health goals. As used herein, the term “food” applies to any liquid or solid, or partially liquid or solid substance that is consumable by a human, and includes biological or synthetic substances.

Accordingly, in one aspect, a health-modulating device for tracking and/or modulating food intake is presented. The health-modulating device may have any shape or size so long as it is capable of assisting in keeping track of the amount and/or type of food a person is consuming. For instance, the device may be in the shape and form of a utensil, such as a knife, fork, spoon, chop-stick, or other such eating and/or drinking utensil; a dish, such as a plate, a saucer, a bowl, a cup, a platter, or other such dish; a container, such as a food container or beverage container; a wristband or necklace or strap; a watch; a scale; strain gauge; a mobile electronic device, such as a computer, a tablet computer, mini tablet computer, mobile phone, PDA, or the like; a mobile medical device, such as an insulin or other type of infusion pump, a heart rate monitor, electronic and/or digital calorie counter, pedometer; or other electronic device designed to measure health, ingestion, and/or athletic activity. In various instances, one or more of these devices may be combined and employed individually or in combination in a system that is formulated to track and/or modulate, e.g., regulate, food consumption and/or increase exercise or other athletic activity.

In one embodiment, the health-modulating device of the disclosure is capable of determining the type and/or amount of food being consumed. By “determining the type of food” is meant any manner by which one item of food can be distinguished from another type of food, such as by physical appearance, e.g., color, physical feel, weight; biological type, e.g., carbohydrate, protein, fat; caloric content or nutritional content; food group classification, e.g., meat, vegetable, diary, etc., as well as specific identification of the particular food item, such as milk, water, beef, chicken, etc., and the like. By “determining the amount of food” is meant any manner by which an incremental amount of a particular food item relative to a whole of the food item may be determined, such as by size, weight, volume, dimensions, caloric content, and the like.

For instance, the health-modulating device may include or otherwise operate in conjunction with one or more auxiliary devices so as to accomplish the objectives herein described. For example, the health-modulating device may be or include, an electromagnetic or magnetic based scanner, such as an optical or light based scanner, such as a laser, RF, or visible light based scanner, a camera, and/or a video device; a scale, a strain gauge, or other weight based measuring device; a sound based measuring apparatus, such as a sonar; an olfactory or taste based scanner; and/or may include one or more sensors, such as a light based sensor, a moisture sensor, a glucose sensor, an oxygen, carbon dioxide, and/or nitrogen content sensor. Accordingly, in various instances, the health-modulating device may include an optical scanner, such as an electromagnetic radiation or laser emitter and/or receiver or other recording device, such as for determining color content, size, shape, volume, weight, and/or dimensions; the device may additionally include still image or video capturing capabilities; likewise, the device may include sound based sensors and/or recording apparatus, such as one or more of a sound emitter and recording device, such as for determining size, shape, dimensions, and the like, so as to enable the health-modulating device of the disclosure to be capable of determining the type and/or amount of food being analyzed.

Specifically, by employing one or more of these devices, and other such devices known in the art, the health-modulating device of the disclosure may be able to determine the type and/or amount of the food being consumed. For instance, one or more emitters can emit a wave of energy, such as a light or sound wave, and one or more corresponding receivers may receive the emitted energy wave, either directly or a reflected or refracted version thereof and from the data contained in the received radiation build or capture an image of the food item contained within or otherwise associated with the device of the disclosure. Hence, the image may be a visual image, a digital image, or a fragment thereof of the actual food item, a representation of the food item, outline thereof, or the like. Once the image is obtained, the health-modulating device may then enter a protocol whereby the identity of the food item and/or its amount are determined. In some instances, the protocol can be implemented by an application executed by a processor of the health-modulating device, or by a processor related to a computer remote from the health-modulating device but which is in communication with the health-modulating device.

For instance, the identity of the food item and/or amount being consumed may be determined in many different manners. For example, the health-modulating device of the disclosure may capture an image or group of images of the food item to be consumed, e.g., via a camera, video, electromagnetic wave emitting device, or other such image capturing device, prior, during, and/or after consumption of the food item or an incremental portion thereof. The captured image may then be analyzed to determine its identity, type, amount, and/or other related type of information desired to be known about the food item being consumed. In certain instances, the health-modulating device of the disclosure includes one or more of a memory, a processor, a transmitter, a receiver, and the like. Accordingly, the captured image may be stored and processed internally, compared to a preloaded database of stored food item images and/or quantities, and a logic based or other comparison based algorithm may be employed so as to compare and determine the type and quantity of the food item, such as by recognition of various predetermined or learned data containing features.

In certain instances, the health-modulating device may include a scanner, such as a barcode, QR code, or other graphical or image scanner that is capable of scanning an encoded graphic or an image, such as a barcode image on a food item wrapper, a QR code on a menu, a dietary content image on food packaging, or other data containing image that contains information about the food item to be consumed, and the like. For instance, in certain embodiments, the health-modulating device may include a barcode scanner, or be associated with a device, such as a mobile telephone device, that includes a barcode scanner and/or barcode scan app, which device is capable of scanning the barcode of the food or beverage and further processing the information contained therein so as to compile and analyze said information and provide the results thereof to the user of the health-modulating device, which user may then use that information to track and/or monitor his or her eating habits. In certain embodiments, the scanner can be associated with optical character recognition (OCR) or other typeface recognition software or firmware, to “read” textual content and other alphanumeric character-based information.

For example, the barcode scanner, and associated application, can process and analyze the scan and then display the information about the nutritional content, including amount and quality of food or beverage, to the user who can then track that information and/or determine his or her choices so as to best modulate his or her eating activities to best accord with their desired objectives. For instance, once the barcode image is scanned, it may be processed and compared to an internal database and memory, which upon recognition of the scanned image, or various data points related thereto, the processor may then process the information, and thereby identify the food type and/or its nutritional content, which information may then be related back to the user or other third party. Hence, in certain instances, the information derived from the barcode scan may be transmitted, e.g., through a corresponding communications link, to a third party, such as a data center to be analyzed remotely, as described in greater detail herein below. In such an instance, a third party analysts may review the barcode scan information and provide a nutritional summary of the food or beverage consumed, which information may be transmitted, such as in substantially contemporaneous time to the user, who can then use that information to inform and/or track his choices.

Accordingly, the health-modulating device may be configured to capture an image, such as a barcode image, and process that information internally, or transmit the captured image to an associated device, such as a mobile computing device, whereby the processing and determination may be performed by that device, such as by a handheld computer, digital assistant, mobile phone, or the like. However, as described above, in certain instances, the captured image and other related data may be transmitted to a centralized data processing center, such as to a computer or computer network, having access to an extensive database, whereby the image processing may take place by the one or more computers in the network. In other instances, the captured image may be sent to a human based processing center, such as where the image and any other pertinent data may be displayed, analyzed by one or more individuals, such as one or more dieticians, health care professionals, sociologist, psychologists, support groups, friends, or other interested individual(s), so as to determine the food type, amount, quality, etc., and/or to provide feedback, such as real time feedback or coaching or support to the user.

For instance, in one particular embodiment, the health-modulating device may be configured so as to keep track of how much the user eats. For instance, a camera on the device, or an associated device, such as a mobile telephone device with photo and/or video capabilities, takes a picture or a video of a plate of food. The picture may be a single photo or a series of photos, such as before the food is consumed, during the consumption process, and/or after all the food is consumed, or at least when the user has consumed all he or she desires to eat. The picture may then be processed by the device itself, such as by generating a digital representation of the photo and comparing various digital points of reference to a database of such references, so as to determine the characteristics of the food consumed, such type, quantity, quality, proportion, nutritional breakdown, etc., and/or the photo may be transmitted from the health-modulating device itself or an associated mobile computing device through a communication link to a data center. The data center, as indicated above, may include a computer or network of computing devices and/or one or more human analysts that may then process the transmitted information, e.g., the photo and any other associated information, so as to provide feedback to the user or a third party. For example, in certain instances, the analysts may review the picture and associated data and provide a nutritional summary of the food, such as including the type, amount, quantity, quality of food consumed, such as by class, e.g., carbohydrates, proteins, fats and/or meats, vegetables, diary, etc. to the data center, user, or third party. The data center may then transmit the generated and analyzed data, e.g., nutritional information, back to the user, e.g., via the mobile computing device, and the mobile device may then give feedback to the user, such as via displaying the nutritional information to the user, and/or providing the user with an auditory or tactile, e.g., vibratory, indication. As described below, such information can be used by a third party doctor, support group, health monitoring commercial entity, friend, coach, or the like, to help assist the user in modulating his or her eating activities. Of course, where positive reinforcement is desirable, a pleasant auditory, tactile, olfactory, stimulatory, or taste stimulus may be evoked, such as by being activated remotely by the 3rd party to promote good eating and/or consumption habits; and where a negative reinforcement is determined as being useful, a unpleasant auditory, tactile, olfactory, stimulatory, or taste stimulus, such as an electrical shock, may be evoked, such as by being activated remotely by the 3rd party to dissuade bad eating and/or consumption habits.

Hence, in certain instances, the health-modulating device is capable of not only capturing information, such as an image or other identification and/or nutritional determining data, but is further enabled for transmitting that data to another device and/or third party, such as for further processing, analyses, and providing feedback and/or coaching to the user. For instance, the health-modulating device of the disclosure may include or otherwise be capable of coupling to a device that includes a communications system. For example, the health-modulating device may include wired and/or wireless communication capabilities. In some instances, the device may include a USB port, a flash port, an HDMI port, a telephone or CAT port, a SDI port, a SCSI port, a SD or SDXC port, or the like. In additional instances, the device may include WiFi, Bluetooth, BLE, NFC, RFID, mesh, ad hoc, and/or other wireless capabilities, allowing the device to communicate, e.g., wirelessly, to remote devices, e.g., via a network or Bluetooth connection, so as to transmit the data obtained, e.g., image data, to a remote device, such as for processing, analyses, and/or real time feedback to the user or other third party.

In certain embodiments, a health-modulating device of the disclosure may further include one or more monitors that may function alone or with a combination of other associated devices to determine the type, quantity, and/or quality of the food to be consumed. For instance, the health-modulating device may include an accelerometer, a gyroscope, an altimeter, a GPS, a magnetic based sensor, or other type of sensors capable of participating in the determination of the amount of food being consumed. For example, anyone or a combination of these devices may be employed in a manner capable of determining the amount of food being consumed by a user of the health-modulating device. Specifically, in certain instances, the health-modulating device may be a utensil, such as a fork or a spoon, or be an attachment capable of coupling to the same. Hence, in certain embodiments, a health-modulating food consumption device of the disclosure, having an appropriate sensor, as described herein, is configured as an attachment, such as in the shape of a laundry close line clip, that attaches to the eating and/or drinking utensil, such as at a position opposed, e.g., distal, to the eating end of the utensil, such as on its handle. Hence, the health-modulating sensing device may be clipped onto an adaptable utensil that is designed ready to receive the clip, or the health-modulating sensor device can be built into the utensil itself. In either embodiment, the health-modulating device will function in the same manner. In such an embodiment, the health-modulating sensor monitors the food being consumed.

To accomplish such, the health-modulating device may include one or more of an accelerometer, a gyroscope, an altimeter, a GPS, and/or a magnetic based sensor, or the like. Hence, as the utensil is moved from a food item, such as a piece of food on a plate, or an amount of a liquid in a glass, and brought to the mouth of the user, the accelerometer, altimeter, GPS, magnetic or light based sensor, can measure the movement and record that an ingestion has occurred. For instance, the user may have a metal or magnetic strip or insert placed at his mouth area, and the health-modulating device, such as a fork or spoon, may include a complementary magnetic component associated therewith, and as the magnets move closer and/or further away from each other, the interaction, e.g., relative movement with respect to each other, between the two is captured and recorded as data that may be processed by the health-modulating device or a computing device associated therewith. A similar set up may be achieved using an optical marking in conjunction with an optical transmitter/receiver, such as where the health-modulating device includes an optical scanner, such as a camera or video camera and an optical indicator is positioned near the mouth of the user, and the device includes programming that allows it to measure the change in distance as the device moves closer to or farther away from the mouth, such as in the eating process. In manners such as these, the number, rate, frequency, and timing of individual and/or collective bites/sips may be determined. The gyroscope, in turn, can measure rotations, which data may be useful in determining when an actual ingestion event has taken place verses simply raising the health-modulating device to one's mouth but failing to ingest therefrom, such as when one raises a toast, but fails to sip.

Further, the health-modulating device and/or an auxiliary device associated therewith may include a strain gauge, scale, or other weight or volume measuring device, which device may function to determine the amount of food being ingested. For instance, a health-modulating device(s) of the disclosure may include an optical or sound emitting scanner, which scanner can measure the volume occupied by a food item, such as a solid or liquid food item, that occupies a predetermined or measured space bounded by the health-modulating device prior to consumption. The decrease in occupied space during the eating process and/or upon its cessation may be incrementally measured by the optical and/or sound emitting scanner. Additionally, or alternatively, a plurality of health-modulating devices, such as those described above and/or below may be employed in a system for the purpose of tracking and/or modulating the food consumption and maintenance of health of a user.

For example, a first health-modulating device may be a plate or glass, which first health-modulating device may additionally be associated with a second health-modulating device, such as a fork, spoon, knife, chopstick, straw, tube or other eating and/or drinking utensil, and wherein the first and second health-modulating devices may each be configured for one or both of measuring a parameter, such as a food consumption tracking and/or modulating parameter, as well as communicating data pertaining to the obtained measurements with its corresponding health-modulating device. In such an instance, more specifically, one or both the first and second (and or third, fourth, fifth, sixth, or seventh, and the like) health-modulating devices may include a scale and/or a strain gauge, such as where the plate includes a scale and the eating and/or drinking utensil includes a strain gauge, such that as a piece of food item is removed from the plate, such as by being lifted by the eating and/or drinking utensil, the scale of the plate health-modulating device registers and records the change in the plate's weight. Likewise, the health-modulating eating and/or drinking utensil registers the gain in weight and/or the movement of the fork or spoon towards the users mouth, and when the food item is removed from the eating and/or drinking utensil, when presumably placed in the user's mouth for consumption, and the eating and/or drinking utensil is returned back towards the plate, this information is registered and recorded by the health-modulating eating and/or drinking utensil.

Where the utensil is a straw, tube or other device to convey liquids or partial solids to a user, the sensor can include a flow sensor to measure a quantity of a food being consumed by way of such a utensil. Additionally or alternatively, such a utensil can include one or more content sensors, to sense or measure, inter alia, alcohol or other content of the food, caloric content, sugar content, biological content, such as bacteria, poison, or other pathogen, or a content of any constituent target portion of the food. Such a utensil can be provided with a feedback alert, such as one or more lights, light emitting diodes, display screens, counters, or the like, which can provide an immediate feedback to a user of the content, quantity or even quality of the food being consumed.

Additionally, a third device, such as a video recording enabled device, such as a smart phone, may be employed in addition to or in exchange for one or more of the aforementioned sensing devices, and may be configured, with the appurtenant software, to record and digitally convert the movements of the one or more utensils and/or decrease (and/or increase) in food items placed on an associated plate or in an associated glass, so as to record and analyze the movements of the health-modulating sensing devices with respect to one another so as to obtain information that a user or a third party, as described herein, can use to track and/or modulate the eating habits of the user. Accordingly, in one embodiment, a health-modulating system is provided wherein a plurality of health-modulating devices are coupled to one another, and may further be coupled to one or more additional sensing and/or recording devices so as to track and/or modulate the consumption activities of a user, such as during a consumption process, for instance, during the eating of a meal such as breakfast, lunch, dinner, or a snack there between. In a first instance, a health-modulating plate, cup, or bowl, etc. is provided, wherein in one instance, the plate or other food bounding item is associated with a weight measuring device, such as a scale device, for instance, a standing scale device, wherein the weight measuring device is configured for sensing weight, e.g., the initial weight of the plate, the initial weight of the plate and food when first added to the plate, and/or the change in weight that occurs to the plate during a period of time, for example, during a food consumption period of time. The health-modulating plate device, and associated scale, therefore may be employed in a system to sense and track the change in weight of the bounded food item(s) upon the plate being consumed during an eating process so as to track the food consumption process, and the system components may further be employed to provide real-time monitoring and/or coaching to the user during the consumption process.

More particularly, in such an embodiment, the scale may be inherent within the dish item, e.g., the bowl or plate or the like, or may be a separate item that is placed underneath the user's plate. As the user removes the food from the plate in preparation for consumption, the change of the plate's weight due to consumption, and/or along with the timing of that consumption (e.g., per bite or per meal), may be measured, e.g., via the one or more sensing devices as described herein, by the health-modulating device itself, or through an associated video recording device coupled therewith, as described herein above, and/or the data derived therefrom may be processed by the device itself and communicated thereby directly to a user, such as through an associated display, such as for real time feedback and modulation, or may be communicated to a remote processing unit, such as at third party processing and analyzing center, e.g., via an associated wired or wireless device, such as a mobile computing device, for instance, a smart phone, for the purpose of tracking and/or providing information to a user that can then be used by that user (or third party) to modulate the user's eating habits, such as in substantially real time. In such a manner, the health-modulating device and/or the mobile computing device(s) associated therewith is capable of providing the user with information about the food item being consumed, such as the type of food and/or weight of the food being consumed and/or the nutritional value, and/or number of calories being consumed, etc. during the meal process. In addition, the health-modulating device and/or associated mobile computing device may determine, e.g., through inference, through digital determination based on captured and digitized video, or through third party human analysis, how many bites occurred, how many bites occurred per minute, how much food was being consumed per bit and over time, as well as the characteristics and qualities of the food being consumed. Accordingly, as stated in this and other embodiments, the information collected by the health-modulating device and/or associated mobile computing device, e.g., smart phone, may also be communicated to a data center for additional diagnostics to be performed. Hence, it is to be noted, that in a manner such as this, or its equivalent, the health-modulating device(s) of the disclosure may be able to generate sufficient data so as to determine the number, rate, frequency, and timing of bits a user engages in during a meal, as well as the amount of food ingested. This information may then be processed, analyzed, and used by the user or a third party for a multiplicity of different uses, such as for modulating the eating and/or consumption activities of the user.

As indicated, once captured and collected, e.g., by the health-modulating device itself, in certain instances, the collective information obtained may then be transmitted to a centralized processing device, such as a coupled handheld computing device, such as a mobile telephone or PDA device, as described above, which device, may process that information itself, or send that information elsewhere, such as to the referenced centralized processing center, for further processing and analysis. It is noted that with respect to the present examples, the health-modulating device(s) may be exemplified as being a plate or bowl or glass or pot, and an associated eating and/or drinking utensil, such as a fork, spoon, knife, chopstick, straw, tube, or the like, such health-modulating devices may also be any other eating device or suitable device such as a bracelet, wristwatch, and the like, capable of tracking and/or measuring the movement of a food item from one position to another, such as from a plate, table, or other storage device, toward the mouth of a user, and/or further may be configured for measuring the change in weight that results from the activities coincident to the ingestion of food, such as the change in weight a health-modulating bracelet or wristwatch recognizes when a food item is picked up by the hand/fork and then deposited in the mouth.

Accordingly, in certain instances, a suitable health-modulating device of the disclosure may be configured as a ring, a bracelet, a band, a watch, eyewear, including eyewear frames, or other ornamental device or the like, which article may be worn, such as on a user's hand, wrist, head or as eyewear, and employed in such a manner that the movements of the hand, wrist, jaw or other parts of the user's head, such as lateral, horizontal, diagonal, and/or rotational movements, along with the speed and/or periodicity of such movements, may be monitored, sensed, and analyzed so as to generate food consumption data that may then be used by the user or a third party to track and/or modulate the food consumption activities of a user. For instance, in various exemplary embodiments, the user wears an ornamental housing, which housing houses the respective sensor and attendant components, at a position such that the movement articulated by the user in the eating process may be measured. In one example, a health-modulating device can include a wearable unit such as a ring, bracelet or armband, to measure the movement and/or speed of a user's arm during eating/drinking of food.

For example, various sensing instruments, such as magnets, may be placed on or near both the upper and/or lower jaws, and the opening and closing of the mouth may be measured so as to determine the number and frequency of bites taken during a chewing process, and/or the pressure generated during the eating process may be measured and determined. In another exemplary embodiment, the sensing apparatus may be housed within a bracelet or watch device, and worn on the wrist of the user, such as the wrist of the hand typically used to manipulate and hold the utensil while eating. In such an instance, the wrist sensor may count the up and down/rotational movements of the user's wrist doing the eating process. The eyeglass wearable unit can, via detections of movement of a user's temple region, ascertain jaw movements to count chews or a carrying of food.

The information gathered by such sensors, such as the number of bites of food being consumed by the user, as described herein, may be used to calculate and determine, e.g., via inference, logical operation of suitable algorithms, 3rd party observation, the data that a user or third party may then use to modulate his or her eating habits. For instance, as indicated above, such information may be used to provide direct feedback to the user, such as by an auditory or tactile indication of the device itself, or through communication to and from a remote processing and analyses center, which analyzes the data and then conveys that data, such as in the form of suggestions and/or coaching, back to the user for behavioral modification. For example, in one such instance, the data obtained by such a wrist sensor, such as a watch containing a sensing device, may be directly displayed by the watch sensing unit. Hence, in one embodiment, a wrist-worn sensor unit, such as a watch or a bracelet includes a display, an alarm, a vibratory unit, an electrical current passing unit, or the like that provides direct feedback to the user. The user may also enable the wrist-worn sensor to communicate through a wireless connection, e.g., via a wireless coupling to a smart phone or other mobile computing device, to a remote data analyses unit.

In various embodiments, such a worn sensing unit, such as a worn strap, band, bracelet, and/or watch sensing unit may be programmed to measure, monitor, and/or modulate a users various other activities besides or in addition to food consumption. For instance, such a sensing unit, such as a wrist worn sensing unit, may be configured to monitor and analyze a user's sleep, action orientated activity, and/or physiological characteristics. For example, a wrist worn sensing unit of the disclosure may be configured for monitoring a user's sleep pattern. In a particular embodiment, the wrist sensor may detect when a user falls asleep, when and how often he or she awakens, the amount of time it takes to fall asleep, or the amount of time spent in a woken up state before falling back to sleep, and the motion of the user during his or her sleep. In certain embodiments, such motion may be used to determine or otherwise infer how much time is spent in various different types of sleep, such as REM or in non-REM sleep. Such calculations are possible because during REM sleep muscles in the arms and legs are temporarily paralyzed. This is thought to be a neurological barrier that prevents us from “acting out” our dreams. Thus, as the wrist sensor detects a lack of movement while the user is asleep, the sensor may infer a state of REM sleep has occurred. Of course, such performance may be coupled with other various physiological sensors, such as oximeters and/or sphygmomanometer or other heart pulse or heart rate monitors to give detailed sleep characteristic data that may be process by the sleep sensor itself, or can be transmitted to a remote processing center for further detailed analyses and data reporting. Such information can be compiled in conjunction with the user's other activities, such as eating and/or exercising, or any combination thereof to determine how one or more of the measured activities effects the characteristics of one or more of the other activities.

In particular, the sensing unit, such as a wrist worn sensing unit, can be configured to measure physical activity, such as walking, running or swimming or other physical activity and the like, and/or may be further configured for measuring a positional and/or physical characteristic or attribute of the user during such activity, such as the user's heart rate, oxygen consumption, C02 levels, power output, lactic acid build up, blood pressure, body temperature, caloric burning, blood sugar content, and the like, and may additionally or alternatively be configured for measuring one or more eating characteristics as described above so as to analyze and correlate the effects that one or more of the activities has on one or more of the others, such as how the amount or rate of food consumption has on one's performance characteristics or physiological states, such as during exercise or sleep.

For instance, a user may have an athletic event monitoring device. The athletic event monitoring device may be configured for measuring and determining a user's athletic performance during an activity, such as an athletic event. For example, the athletic activity sensing device, e.g., wrist worn athletic sensing device, such as a watch, may include a pedometer, an accelerometer, a GPS, a clock, a counter, a stop watch, a GPS, a gyroscope, a strain gauge, and/or the like, which sensing devices may be configured for measuring their respective positional, timing, and/or motion detection characteristics of a user, such as while engaged in a physical activity so as to generate data pertinent to the users performance ability while performing the given activity, such as his or her speed, acceleration, distance covered, height or depth achieved, power generated, and the like. Additionally, a wrist worn sensing unit, as described herein above, may include one or more physiological characteristic measuring devices, such as a heart rate monitor, an oximeter, a capnographic device, a power generation sensor, a lactic acid measuring device, a sphygmomanometer, a thermometer, a caloric burning measuring device, a blood glucose monitor, and the like, which devices may be configured for measuring one or more physiological characteristics, such as the user's heart rate, oxygen consumption, C02 levels, power output, lactic acid build up, blood pressure, body temperature, caloric burning, blood sugar content, and the like, for instance, while participating in an athletic activity, such as running or swimming and the like.

In various instances, the sensing unit, such as a wrist worn sensing unit, may also, or alternatively, be configured for measuring a health-modulating sensing characteristics and/or one or more sleep quality characteristics. Hence, a health-modulating sensing device may be configured for measuring one or more of a health-modulating sensing characteristic, as described above, a sleep characteristic, performance characteristics, such as while performing a mobile activity, and/or a physiological condition, such as during food consumption, sleeping, and/or while performing an athletic activity. For instance, a user may have a health-modulating sensing device, as described above, and may further have a sleep sensing and/or athletic event and/or physical condition monitoring device, as also described herein above. Such a device may be useful for measuring a positional and/or physical characteristic of the user during an activity, such as eating, sleeping, or performing in an athletic activity. Such devices may be used alone or in combination with one another and/or an additional computing device, such a mobile computing device, e.g., a smart phone, or remote computer to generate data that may be used by a user or a third party, as described herein above, to modulate the behavior of the user and promote the health characteristics of the user.

For instance, one or more of the data generated by a physical activity measuring device that has been sensed or calculated so as to determine a performance characteristic of a user in the performance of an activity may be correlated to the data generated by one or more of a physiological characteristic measuring device that has measured a physiological characteristic that has been sensed and measured by the one or more additional sensing devices as described above. Additionally, the data generated by one or more sleep monitoring devices and/or health-modulating devices, as described above, can also be computed, analyzed, and collated so as to determine the consequent interrelationships of the data points with one another, so as to determine how the various sensing modalities affect one another. For instance, a sensing unit of the disclosure may itself, or in combination with a remote computing function, measure various sensed data, or collate the same, so as to determine one or more physiological, physical performance, sleep, and/or consumption interrelationships. For example, one or more of the above described data may be generated, captured, and analyzed, as described herein above, so as to determine how a user's sleep characteristics affects the user's athletic performance characteristics and/or the user's food consumption characteristics, or how the user's athletic performance characteristics affects the user's sleep characteristics and/or the user's food consumption characteristics, as well as how the user's food consumption characteristics affects the user's athletic performance characteristics and/or the user's sleep characteristics. This information, and its inter-relationships may then be used by the user or a third party to track, monitor, and/or modulate the user's behaviors, such as in relationship to the user's food consumption, sleep characteristics, activity performance, and/or physiological conditions.

Accordingly, in exemplary embodiments, a sensor-containing device of the disclosure may be capable of a single or a multiplicity of functionalities to engage in and satisfy a multiplicity of purposes such as those listed herein above. As indicated, the sensing device may comprise a wide variety of other sensing and/or measuring devices, such as a GPS, a clock, a timer, a stop watch, an accelerometer, a gyroscope, a hold/proximity sensor, and the like, as well as one or more biological sensing devices, such as describe herein above, so as to achieve the objectives of the disclosure. Hence, the sensor functionalities may measure the movement of the user's body, or a portion thereof. For instance, the sensor may be configured in a multiplicity of different manners so as to measure finger, hand, wrist, arm, shoulder, head, jaw, hip, leg, ankle, and/or foot movements to measure and determine useful data points from which a user's behaviors may be determined, coached, and/or modulated, such as in accordance with a predetermined code of conduct or standard. The sensing device may range from simple to complex, depending on the user's requirements. For a simple sensing device, the sensor may count the number of bites, determine the rate of the bites, the pressure generated by a bite, the size of the bite, and/or provide the weight, nutritional value, and/or characteristics of the food item being consumed. For a complex device, the sensor may determine one or more dietary characteristics, sleep characteristics, performance characteristics, and/or physiological conditions, and determine the relationships between the same, so as to generate a user profile, which user profile can be used by the user or a third party, such as a doctor, healthcare provider, or coach, to track and/or modulate the activities of the user, e.g., with respect to eating, sleeping, and participating in various activities, so as to increase the health and efficiency of the user.

Accordingly, as described herein above, one or more of the aforementioned data sets once generated may be used locally, by the health-modulating sensing device, or transmitted to a remote processing center, such as a computer network or human based analysis center, which processing center will receive the transmitted data, store, process, and analyze the data so as to generate useful relationships from the data, which relationships may then be used to provide constructive feedback to the user. For instance, the health-modulating sensing device may locally analyze the data, or rather provide input via wired or wireless transmission to a coupled computing device, such as a mobile, handheld computing device, e.g., a smart phone, that may itself analyze the data or further provide that data, either raw or somewhat processed to a remote analysis center for enhanced processing, such as in an interactive approach, where various algorithmic logical functions and computations are performed on the data to generate data sets that may be used to characterize the users activities. For example, the sensing device may provide the number, time, and frequency of arm movements, e.g., while eating, sleeping, or performing an activity, as well as any consequent weight changes coincident with the activity, and provide that information directly to a third party processing center or to the same via a mobile computing device, which processing center and/or mobile computing device then runs one or more logical functions on the data so as to determine one or more outcomes, such as the amount of calories consumed, for instance, while eating, while sleeping, and/or while performing an activity. An example of such a computation is that the number of calories the user is consuming in real time may be determined as a function of the weight of the food consumed and the number of times that amount of food is consumed, or the number of calories burned may be determined as a function of the amount of movement detected during sleep or other athletic activity.

Once the data has be captured, analyzed, and various relationships determined, the output information may then be communicated back to the user, such as in any manner suitable to convey one or more interpretable instructions to the user. For instance, a health-modulating sensor of the disclosure may include one or more visual, auditory, and/or tactile indicator, such as on a handle of the device, which indicators are capable of providing feedback to the user. Such immediate indicators may include lights, displays, sound alarms, and vibration. These indicators may be generated by the device itself, or may be transmitted as signals to a different device, such as an associated mobile computing device that then displays or otherwise performs the indicating function. In various embodiments, the data may not be fully computed and correlated by the health-modulating sensor device and/or by an associated mobile computing device. Rather, as described above, the data may be transmitted to a remote analyses center, such as a remote computing, e.g., supercomputing, center, or to a human based analyses center.

Such a third party human services center may perform several different functions on the data so as to analyze the data and report back to the user. For instance, the analyses center may review transmitted photos and text data and interpret the same, either representational or mathematically. For example, the analyses center may break a photo of a plate of food items, before, during, and/or after consumption, into its component parts, and relate this data to transmitted data pertaining to the weight of food consumed (totally or as a function of mouthfuls) and the number of bites taken and thereby generate a food consumption profile that describes the meal as a function of frequency of bites taken, amount and characteristics of food consumed, and time period of consumption, which data points may then be compared to an ideal data set so as to generate recommendations that may be communicated to the user.

For instance, a generated data set may include a breakdown of types and characteristics of food items consumed, the number and length of chewing, the calories taken in, as well as the nutritional value achieved by consuming the meal, which data may be compared, either by a software program or by a human analysts to an ideal data set so as to generate recommendations pertaining to behaviors of the user that may be changed so as to promote better eating habits and overall health. It is to be noted that although the preceding was described with reference to food consumption, the same process may be employed so as to generate useful recommendations in the sleep and exercise patterns of the user, depending on the sensing mechanisms being employed and the activity being engaged in. And as described above, one or more of these activities and the data sets generated by the sensing mechanisms set forth herein, may be combined the analyses of the data sets compared to generate a more detailed user characteristic profile and consequently a more detailed set of recommendations for changed activity. For example, a negative relationship may be determined between the amount, type, or speed with which food is consumed and the amount of sleep or athletic performance achieved, in which case one or more recommendations may be generated advising the user as to how he or she may change their eating activities so as to sleep or perform better or simply to better ensure quality of health.

Such recommendations may be generated automatically, such as by correlations recognized in accordance with predetermined algorithms run in a computer database, or via analyses performed on the data by a third party. By “third party” is meant any entity other than the user that has access to the data and may use the data to produce an outcome, such as a recommendation, e.g., a recommendation for a behavior change or an encouragement for the maintenance of an activity or the like. A typical third party could be a doctor, a health care professional, a pharmacist, a dentist, a psychiatrist, a psychologist, a support group, a friend of the user, an insurance provider, a commercial entity engaged for the purposes of analyzing the data and/or providing recommendations, a scientist, a researcher, a government regulatory agency, a legal professional, a supporter, a coach, and the like. A typical output of the analyses is a recommendation. A recommendation may be any communication generated and to be transmitted to the user or a third party and directed at improving the diet, sleep, performance, and/or overall health of the user or other person or population of people. In particular, a typical output may include the raw data generated by the sensed activities, interpretations of the raw data, comparisons based on the raw data and some other data, such as tables of ideal data sets, a breakdown of the raw data sets into component parts and/or groupings, such as a plate of food being broken down into its food groups, classes, e.g., carbohydrates, sugars, proteins, amino acids, fats, fatty acids, triglycerides, and the like, etc., as well as suggestions or detailed instructions as to how to change a behavioral activity, e.g., eat more vegetables, reduce carbohydrate consumption, chew more, chew longer, drink more water, etc. that when communicated to the user will guide the user to change his or her behaviors and better assist the user in achieving his or her dietary and/or overall sleep, physical and/or health goals.

In certain embodiments, the disclosed analyses services may be provided by the analysts and/or food coaches and/or by an automated computer system on a pay basis. For instance, a food analyst or coach may send a user periodic, e.g., daily or weekly, or monthly, or annual reminders, updates, analysis results, instructional recommendations, or the like, to the user, either directly to the sensing device or through another receiving device, such as a mobile phone, e.g., a smartphone, or email, etc. The analysts, food coaches, computer system, and the like may monitor the progress of the user and provide feedback as to what steps the user should contemplate taking in order to achieve the “ideal.” Such a feedback loop may be provided to the user through the user's sensing device, mobile phone, or related smartphone app., and/or through email. In certain instances, such feedback may be instantly posted on a user's or third party's Facebook® page, or via Twitter®, or on Instagram®, Flicker®, and other social media modality. In any event, once a recommendation has been generated, it may be communicated to the user or a third party.

According to various embodiments, the data sensed, generated, compiled, analyzed as well as the output data generated and transmitted in response thereto may be managed, in all of its aspects, by a Smartphone application, or “app”. Hence, in certain aspects, a Smartphone app is provided, wherein the Smartphone app is configured for keeping track of the user's daily food intake, nutritional breakdown, sleep quality, and exercise levels, as well as the various outputs, including recommendations, generated and transmitted by the third party analyses center, if include in the particular manifestation of the embodying system. In a manner such as this, the user's progress may be tracked against pre-selected “ideal” (i.e. one or more quantitative or qualitative thresholds) daily food intake, nutritional value, sleep characteristics, and exercise levels, such as where the user and/or a user's third party representative, e.g., food coach, select what constitutes the “ideal,” and monitor the user's progress against the “ideal.”

In certain embodiments, the Smartphone app may be configured to automatically turn on, prior to eating, shut off after eating and, log all the users other activities, such as activities engaged within in between meals. The app may also make use of the Smartphone's inherent programming and features to ensure the communicative aspects of the above set forth procedures are duly performed. Hence, the Smartphone app, or other software provided to the electronic sensing devices, disclosed herein, or associated computer hardware, is configured for enabling the sensing devices and associated computing devices (if included) to carry out the operations sufficient for performing one or all of the tasks disclosed herein. Such operations may include performing a sensing operation, an analytical characterization in response to the results of the sensing operation, transmitting and/or receiving instructions in response to the sensed or analyzed data, the sending and receiving (such as by text or email message) of data, including sensed data, analyzed data, and instructional data, e.g., recommendations, as well as performing the indicator operations, such as sounding various auditory, tactile, or visual alarms, in response to received instructions and/or recommendations. For instance, the present disclosure, in its many embodiments, comprises software, such as software for a Smartphone app. or other computer readable media that may be read, stored, and executed and/or performed on any other computing device, such as the devices disclosed herein. Accordingly, in one particular embodiment, the software, e.g., the Smartphone app, provides the user with the ability to take a photo of a food item to be consumed, or to scan the barcode of the packaged food items, and, in various instances, to analyze that data and/or send it to a food coach, or the like, wherein the food coach, or another computing device, may analyze the nutritional contents revealed by the transmitted data, and provide the outcome of such analyzed information back to the user, such as through the Smartphone app. In certain instances, the software, if contained in the sensing device itself, or on the smartphone, if a Smartphone app, may automatically launch when the sensor operational interface is depressed, or when the sensor is attached to an eating and/or drinking utensil, such as by being pressed and indicating the start of a meal. Similarly, the software, e.g., Smartphone app, may automatically launch when the wireless standing scale is activated. For instance, a scale, as described herein, may be activated by an on/off button or by placing a plate on top of it. In certain instances, the Smartphone app, and/or other associated programming, may be configured to transmit a cautionary signal to the user's device if the user is not chewing slow enough, is falling asleep, or has missed a workout, or the like. For example, the Smartphone app, or other associated programming, may send the user a text or audible message, may sound a chime or other alarm, such as a vibration or change in a schema being displayed, or the like, if the user is not exercising enough. Such actions may be sent to the mobile device itself, to the sensor device, or to a third party, which third party may then check in on the user.

Accordingly, in certain aspects, the present disclosure is directed to software to be stored as executable instructions within the memory of a database, or as machine readable code stored on a physical computing media, and further directed to the hardware necessary for executing the machine readable code and performing the one or more, e.g., all, the instructions relevant to carrying out one or all of functions of the electronic sensor described herein. Both the software and the hardware are equipped with the appropriate coding and modalities sufficient for performing all the activities of the sensing devices disclosed herein.

As indicated above, the above-mentioned features and aspects of the present disclosure will now be described in greater detail with reference to the following description taken in conjunction with the accompanying drawings. It is to be noted that although various embodiments have been depicted as representational in accordance with the appended figures herewith, the particular embodiments so presented are not meant to be limiting. Accordingly, although a particular representation embodiment may be depicted, such as a suitable health-modulating device, being depicted herein as a clip capable of being attached to a utensil, it is understood that the health-modulating device may be configured as the utensil itself, a dish, a cup, a bowl, and/or the like.

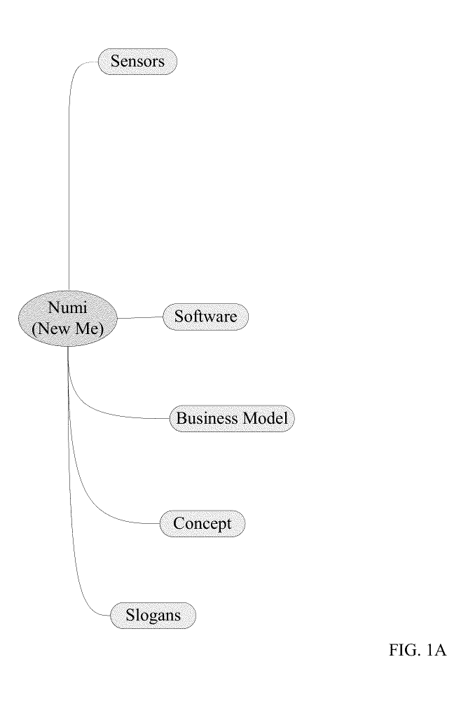

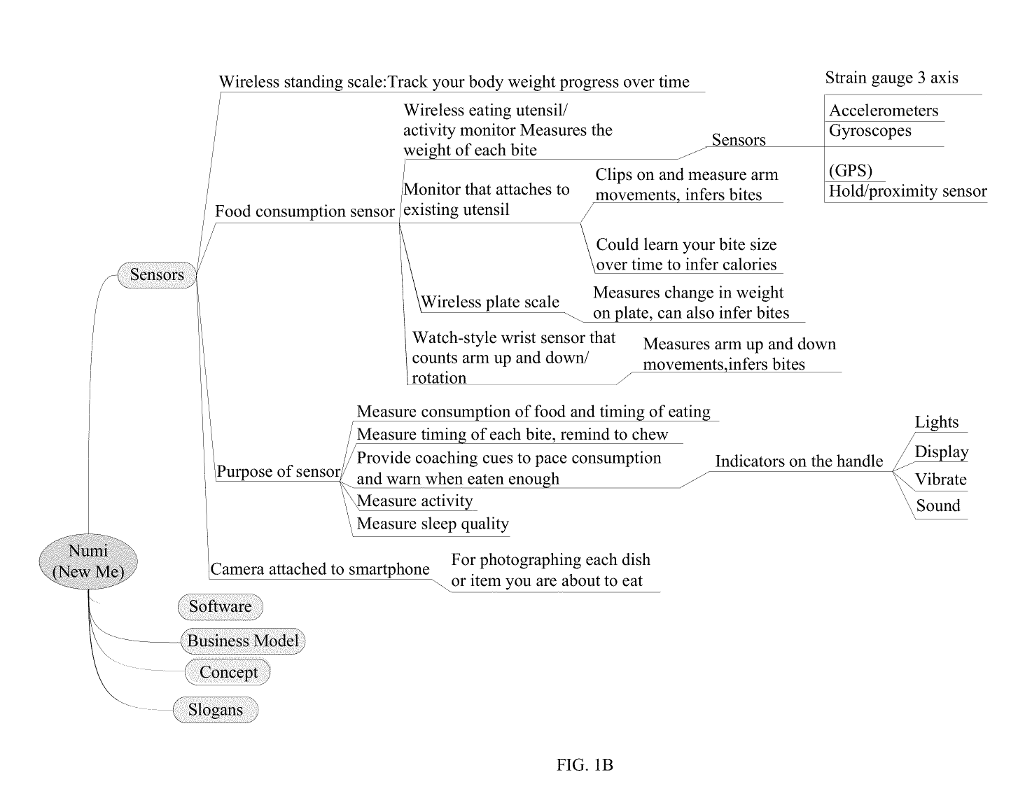

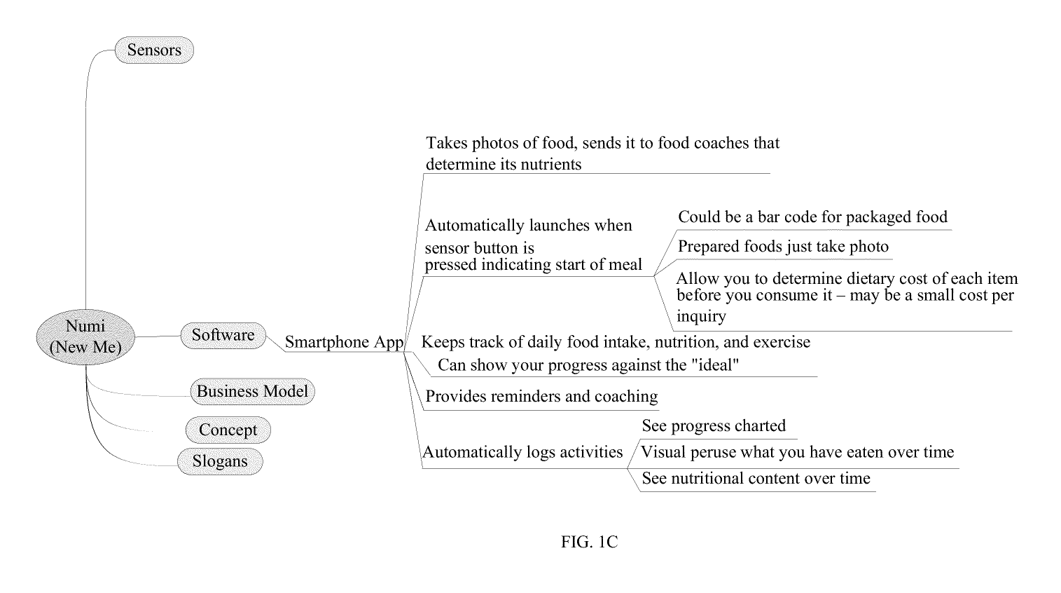

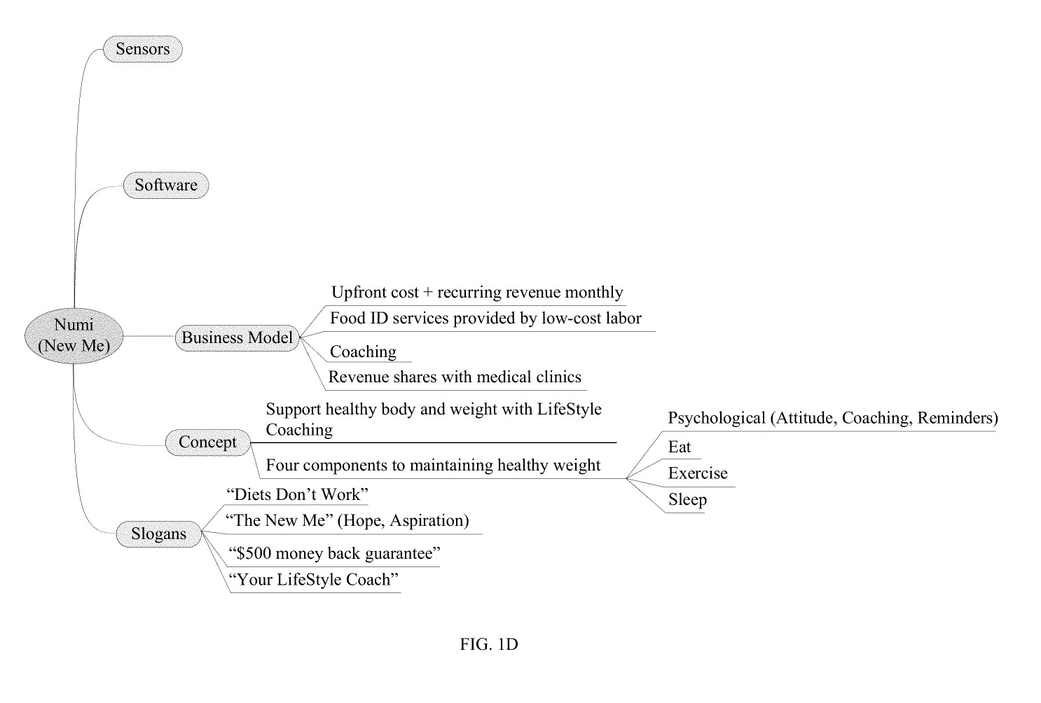

Accordingly, FIG. 1 presents a graphical representation of various exemplary features of the devices, systems, and methods of the disclosure. As can be seen with reference to FIG. 1, in some particular embodiments, a representational health-modulating device of the disclosure may be a clip that is configured for being attached to a different, separate object, such as a utensil; or may be the utensil itself; or a plate or dish, etc. In certain embodiments, as depicted in FIG. 1, a representational health-modulating device of the disclosure may be configured as a separate, computing device, such as a mobile computing device, e.g., a smartphone, or even configured as a band or a watch that can be worn around the wrist. As depicted, a health-modulating device of the disclosure, whatever its configuration, may include one or more sensors for measuring a personal characteristic or representation; may include a process and memory for storing executable instructions, as well as the architecture for executing such instructions, such as in the form of a software application, e.g., a Smartphone app; and may be designed to function so as to generate external data of one or more conditions that may then be processed internally or sent, e.g., via a wireless transmitter, to a remote processing center where at an analysis framework, e.g., of people and/or computers, can collate and process that data in such a manner that one or more analyses protocols may be executed so at generate a user specific output, which output can then be interpreted and employed by a third party, e.g., a health, dieting, sleep, and/or exercising clinician, health care professional, or coach so as to provide, instructions, guidance, and/or support to the user, such as in substantially, contemporaneous real time. A further unique aspect of the disclosed devices, methods, and systems is that the methods and systems herein disclosed provide for a billing operation that is flexible and can be a one time or repeating event, thereby supporting a recurrent revenue stream for greater commercialization of the devices systems disclosed herein. The cost of which can be offset in part by sharing the same with various partners, such as medical clinics and or government agencies. Hence, in some instances, a pay-per-click billing model may be provided whereby a user is billed and/or charged automatically a certain fee every time they select to send the sensed data to a third party, remote analysis center.

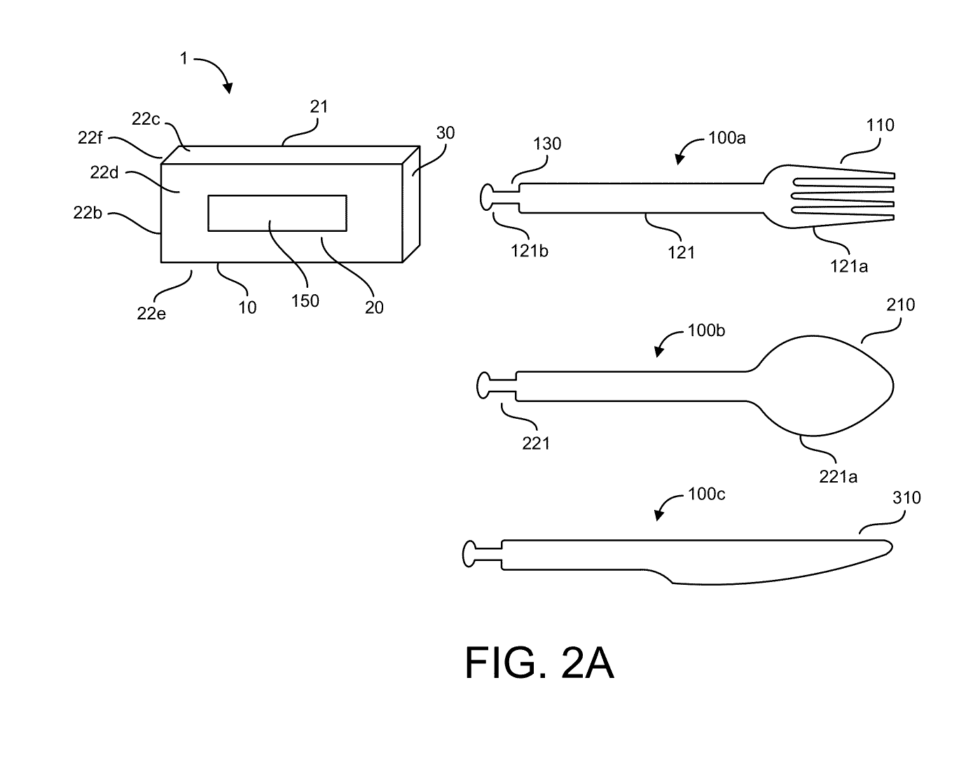

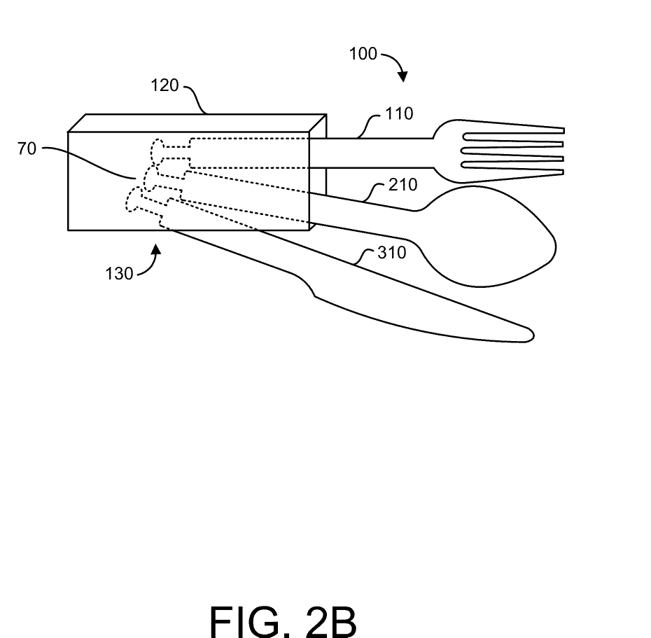

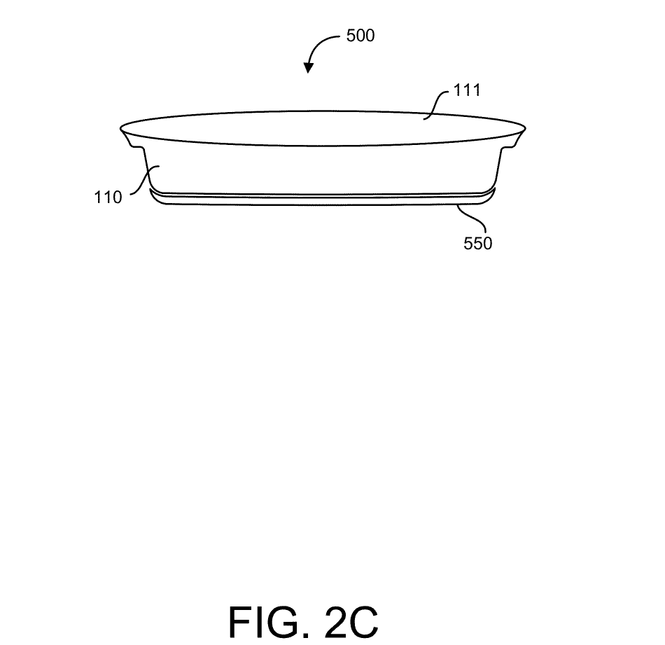

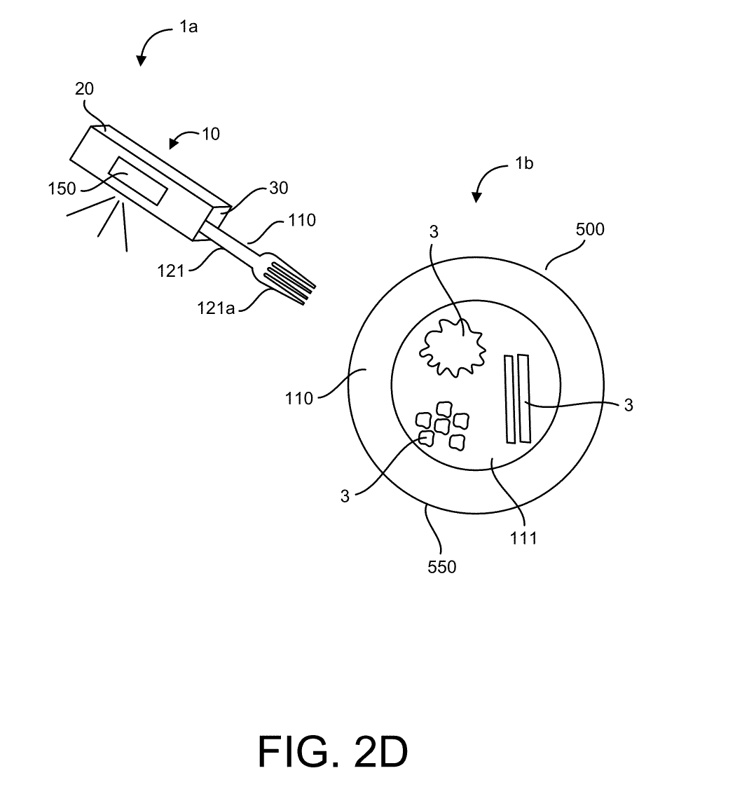

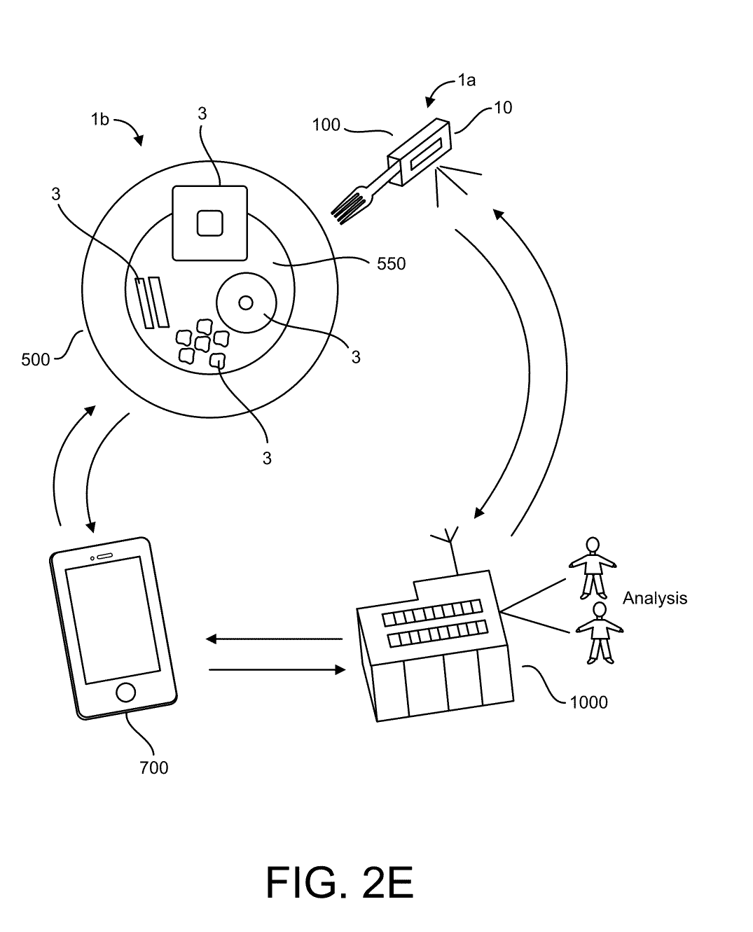

As can be seen with reference to FIG. 2, a representational system of the disclosure is provided. The system may include a health-modulating sensing device 1, such as a utensil and/or dish, and as depicted with reference to FIG. 2A may be a clip element 10. So depicted, the clip element may include a bounding member 20, which bounding member bounds a receiving receptacle 30. In this embodiment, the clip element 10 may have any shape and/or configuration so long as it is capable of being coupled either physically, e.g., removably coupled, or electronically, to one or more secondary objects. For example, in various instances, the clip element may be configured so as to be physically, removably coupled to a utensil element, such as a utensil, dish, glass, or even to a part of a user, for instance, to the wrist or waist or foot, of the user and/or to the user's clothing and/or accessories, e.g., shoes. Accordingly, in this embodiment, the clip element 10 may include a coupling mechanism, which coupling mechanism may have any suitable configuration so long as it is capable of coupling the health-modulating clip 10 to a separate object, such as here depicted utensil 100.

For instance, as here depicted the clip element 10 is configured so as to include receiving receptacle 30, which receiving receptacle 30 is configured to receive and interface with a portion of utensil 100. In practice, the receiving receptacle 30 may have any configuration and/or shape so long as it is capable of receiving and/or fastening onto a secondary object, such as utensil 100. In this instance, the interface between the interior of the bounding member 20, forming the receiving receptacle 30, is such that a snug fit is provided between the bounding member 20 and the clip interface portion 130 of the utensil. In certain instances, such a snug fit is important so as to ensure the accuracy of the sensing function of the health-modulating sensing device 1. However, in other embodiments, a snug fit is not required and so being the receiving receptacle 30 may be configured to couple loosely to the secondary object. Accordingly, in certain instances, the clip element 10 may include a coupling mechanism configured quite differently than receiving receptacle 30. For example, dependent on the nature of the association to be achieved the clip element may have one or more coupling mechanisms that may be configured in a variety of different manners, such as a stickpin, a button pin, a safety pin, a button, a buckle, an adhesive, a screw thread, a cam thread, a stitching, a fastener, such as a hook and loop fastener, a smaller clip element, a clamp, a hinge element, a fold, an articulating element, a pressure fit, a compression fit, a weld, a rivet, a tie thread, and the like.

With reference to the bounding member 20, the bounding member may have any configuration or shape suitable to the device, so long as the bounding member 20 is capable of housing one or more of a sensing and/or computing and/or display function of the health-modulating device 1. In this embodiment, the bounding member 20 has an extended body 21, which extended body 21 includes a plurality of opposing sides, 22c, 22d, 22e, and 22f, and further includes a distal end member 22b. In this embodiment the extended body 21 does not include a proximal end member 22a (not present), but in various other embodiments a proximal end member 22a may be present. It is to be noted that with respect to the depicted embodiment the bounding walls or sides of the extended body 21 are in a fixed relationship to one another, and thus immovable with respect thereto, however, in other embodiments, one or more of the bounding walls or sides may be movably coupled to one or more of the other bounding members or sides. For example, in certain embodiments one or both of proximal and/or distal end members may be present wherein one or both of the end members may be removably coupled to the walls 22c, 22d, 22e, and/or 22f of the extended body 21, such as where one or both of the opposing end members form removable or rotatable cap pieces to the extended body 21, such as where it might be desirable to have a receptacle, e.g., a receiving receptacle 30, but also have the ability to partially or entirely enclose said receptacle 30.

As the opposing sides and opposing end members may be any suitable distance apart from one another, and in any suitable shape, the size and dimensions of the receiving receptacle 30 may vary, such as in relationship with the type of secondary object 100 the health-modulating device 1 is to be associated with. Specifically, as depicted here, the secondary object 100 may be a utensil, such as a fork 110, a spoon 210, a knife 310, etc. For instance, as depicted, the utensils 100 are elongated and especially formatted for being removably, and snugly coupled to the health-modulating sensing device 1, such as by insertion of a portion of the utensil 100 into the receiving receptacle 30. For example, the extended body 121 of the utensil 100 has a proximal portion 121a and a distal portion 121b, wherein the proximal end portion 121a is configured for interfacing with at least a portion of a food item as well as a user's mouth, and the distal end portion 121b is configured for interfacing with the elongated body 121 of the health-modulating device 1, such as by insertion into the receiving receptacle 130. Accordingly, to facilitate this coupling interaction, the elongated body of the distal portion 121b includes two different lengths, a length X, which length is selected so as to ensure the stability of the eating apparatus, and a length X−1, which length is selected so as to ensure a snug coupling within the receiving receptacle 130.

Hence, in various embodiments, a kit and/or system may be provided wherein the kit includes one or more health-modulating sensing devices 1, such as depicted herein, as well as one or more utensil attachments, such as fork attachment member 110, spoon attachment member 210, and/or knife attachment 310. In such a manner, the methods of the disclosure may provide for the concomitant eating and sensing of eating actions via the use of respective knife elements, fork elements, and/or spoon elements, either in parallel or sequentially, e.g., via sequential attachment of the utensil element 100 with the sensing device 1. Accordingly, as depicted fork element 110 is coupled to the health-modulating sensing device 1, and ready for use, however, as desired the fork element 110 can be decoupled from the health-modulating sensing element 1, such as by applying a pulling force to the proximal end portion 121a of the fork element 110, and the spoon (or knife) element 210 may be coupled to the health-modulating device, such as by applying a pushing force to the proximal end portion 221a of the spoon element 210. Of course, in certain instances, the coupling and decoupling can be automatic such as by the employment of a retaining and/or ejection element such as a magnetic or electric coupling mechanism or a mechanical coupling/decoupling mechanism such as via a spring loading mechanism.

As depicted, the health-modulating sensing device 1 further includes a display 150. The display may be operationally coupled to the sensing element (not shown) of the device as well as to an included processing and memory storage element (both of which are not shown). The display can be any type of display, such as an interactive, touch screen display. Hence, the display may be a TFT, LED, LCD, Plasma, OLED, AMOLED, Retina display, and the like. Hence, the display is configured for receiving sensed and/or processed and/or analyzed data from the processor and displaying the same to the user. Additionally, in certain embodiments, the health-modulating device 1 may further include a transmitter and/or receiver operationally coupled to one or more of the processor, memory, and/or display, in which instance, the display may be configured for displaying incoming messages and or images received by the receiver of the device, such as from a third party analysis facility and/or a coach. Consequently, as the utensil 100 in association with the sensing device is used to cut and transfer a food item to a user's mouth for consumption a change in the weight of the utensil 110, e.g., proximal portion thereof 121a, and or a change in the position of the food item is sensed by the sensor, e.g., as one or more of a weight differential and/or a positional change in three-dimensional space, e.g., including rotational motion, that information is stored in the memory, and/or may be processed and/or analyzed by the processor, and/or transmitted, e.g., wirelessly to a secondary or tertiary computing device, such as to an associated handheld computing device, e.g., a smartphone, or a third party analysis center, respectively. Additionally, the health-modulating device 1 may further include one or more sound emitting elements and/or light emitting elements, and/or vibratory elements to further draw the attention of the user and or communicate received data thereto.

In certain embodiments, as can be seen with respect to FIG. 2B, a clip element 10 of the disclosure may be of a size and dimension so as to house one or more of the utensil elements 110, 210, and/or 310, such as within receiving receptacle 130, for instance, when the utensil elements 100 are coupled to the elongated body member 120 of the health-modulating device 1 so as to be in movable, e.g., rotational alignment therewith, consequently, in this configuration, the receiving receptacle 130 forms a cavity which cavity is bounded by bounding member 120 in such a manner so as to form a housing configured for receiving and thereby housing the moveable, e.g., rotatable utensil elements 100. Accordingly, when not in use, the utensil elements 100 are received, e.g., entirely received within the receiving receptacle 130, e.g., so as to be flush therewith, and when desired, the appropriate utensil element 110 may be rotated out of the housing 10, such as around pivot element 70 so as to be used as desired, for example, in an eating procedure.

As can be seen with respect to FIGS. 2C and 2D, another health-modulating sensing device 1 of the disclosure is presented this time depicted as a dish 500, which dish 500, in this embodiment is coupled with weighing mechanism, e.g., scale 550. In this embodiment, the plate 500 has an extended and circular body 110 that forms a concave surface 111, which concave surface is configured for receiving one or more food items. It is understood that although health-modulating device 1 herein is depicted as a dish, the health-modulating device could just as well be a bowl, a jar, a saucer, a platter, or other food container, and the like. Accordingly, the plate 500 is configured for both receiving one or more food items and being positioned on a weighing element 550 in such a manner that as various food items, or portions thereof are added or subtracted from the plate 500, such as during an eating procedure, the weight of the plate 500 changes, which weight change is indicative of a consumption event. Hence, as with respect to the health-modulating device of FIGS. 2A and B, the plate health-modulating device of FIGS. 2C and 2D also includes one or more of a sensing device, as described in detail herein above, in operational communication with one or more of a processor, a memory, a display (which may or may not be included, absent here), and/or a transmitting and/or receiving device. Consequently, as a food item, or a portion thereof is removed from the plate 500, a change in the weight of the plate 500 is sensed by the sensor, that information is stored in the memory, and/or may be processed and/or analyzed by the processor, and/or transmitted, e.g., wirelessly to a secondary or tertiary computing device, such as to an associated handheld computing device, e.g., a smartphone, or a third party analysis center, respectively. Once the data is analyzed, as described in detail above, such as in real time, an instruction, such as a coaching protocol, may be communicated to the user such as to the health-modulating sensor device 1 directly, so as to be displayed or otherwise indicated thereon, e.g., to be displayed on a display of the device or indicated by an indicator, such as by a vibratory element, a flashing element, or a sounding element; or the protocol may be communicated to an associated secondary device, such as a handheld computing device, e.g., a smart phone.

For instance, as can be seen with respect to FIG. 2F, a system in accordance with the disclosure is provided. In this embodiment, the system includes a plurality of health-modulating devices 1a and 1b, such as plate 500 and utensil 100/sensor clip 10 combination. The system further includes a secondary computing device, for instance, smartphone 700. The system additionally includes third party analyzing facility 1000. Each of these elements has the components discussed in detail above. In this system, plate 500 has food item 3 positioned thereon. In this embodiment, scale element 550 is not a separate element from the plate 500, but is an intrinsic portion thereof. Accordingly, as food element 3 is positioned on the plate 500 the scale element 550 weighs the food element and this data is stored in the memory element of the plate and/or communicated to secondary computing device 700. Now, as the combination sensor clip 10/utensil element 100 is employed in an eating protocol several actions take place virtually simultaneously. The plate sensing device 500 registers the ever decreasing weight loss that results from food items being removed from the plate 500, while the sensor clip 10 registers the movements of the utensil element 100 away from and toward the plate, sequentially, including the rotational movement caused by the turning of the wrist to facilitate depositing of the food item from the plate into the mouth of the user, in conjunction of the weight loss experienced by the utensil 100 as the food item is removed from the utensil 100 and deposited in the mouth such as for consumption. This data again in some instances may be stored and/or processed locally such as within a computing center in the actual health-modulating devices 1 and 500, however, in this embodiment, the data is transferred, e.g., wirelessly, such as via wifi or Bluetooth interface to the secondary computing device 700, which in this embodiment is a smart phone.

The secondary computing device 700 plays many roles as this system is presently configured. First, for instance, the secondary computing device 700 is employed to take a picture of the plate 500, e.g., prior to food items 3 being placed thereon, immediately after food items are placed thereon, and one or more times until the food items 3 are completely consumed or the user is finished eating. These photos may then be transmitted to third party analysis facility 1000 for further processing. Additionally, the progressive data dumps transmitted to the secondary computing device 700 by the plate 500 and the sensory clip 1 are transmitted to the third party analysis facility as well.

The third party analysis facility 1000 may then receive and process the data, which data may then be analyzed and an outcome generated. Once generated, the outcome may then be transmitted back to the user, such as by being transmitted to one or both of the health-modulating device(s) and/or to the secondary computing device 700. Several different analyses protocols may take place with respect to the generated and compiled data at the analysis facility 1000, which one or more protocols may be run by a computer, series of computers, and/or by human analysts. The type, category, nutritional content, and classification of the food may be determined such as by analyzing the received photos. This may be done by computer with access to a reference to a digital database, or by a human with reference to a photographic database, for example. Additionally, the caloric intake may be determined as well as the speed of chewing, swallowing, and eating may be determined. This data and other such data may then be compared to a preselected ideal or compared to a statistical developed mean of a population of individuals or a population of incidents of the same individuals well as a combination thereof. These and other types of analyses as described herein and known in the art may be performed to produce a result. The resultant analyses may then be employed by a third party computer or human analysts so as to provide feedback to the user regarding the eating process currently taking place or having taken place in the past. This information may be in any suitable form and is intended to encourage and/or instruct the user in developing better eating habits, in this instance, in other instances, better sleeping habits, better exercise habits, and the like, so as to promote the overall health of the user.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A personal health modulating system comprising:
a mobile computing device comprising at least one electronic data input for receiving electronic data, at least one wireless transceiver for communicating with a wireless network, and an interactive display;
at least one sensor to sense an environment that is external to the mobile computing device, to gather data representing one or more attributes related to an activity of a user, and to transmit the data to the at least one electronic data input of the mobile computing device; and
an internal processor that is internal to the mobile computing device, the internal processor executing an application to receive, via the at least one electronic data input, the data representing the one or more attributes related to the activity, to process the data according to one or more personal health modulating data processing routines, and to generate a graphical user interface for display on the interactive display of the mobile computing device, the graphical user interface providing a representation of at least one of the one or more personal health modulating data processing routines.

2. The system in accordance with claim 1, wherein the at least one sensor is a scale that is configured to weigh food for consumption by the user.

3. The system in accordance with claim 2, wherein the scale is adapted for fitting under a plate that holds the food.

4. The system in accordance with claim 1, wherein the at least one sensor is a machine-readable code reader that is configured to read a code associated with a package of food for consumption by the user.

5. The system in accordance with claim 1, wherein the at least one sensor is a camera that is configured to acquire a digital image of food for consumption by the user.

6. The system in accordance with claim 5, wherein the camera is integrated with the mobile computing device.

7. The system in accordance with claim 5, wherein the camera is external to the mobile computing device.

8. The system in accordance with claim 1, wherein the at least one sensor is a sleep sensor to be worn on or near the user for measuring sleep patterns of the user.

9. The system in accordance with claim 8, wherein the sleep sensor is integrated with a wrist band.

10. The system in accordance with claim 1, wherein the application executed on the internal processor is further configured to transmit, via the wireless network by the at least one wireless transceiver of the mobile computing device, the data processed according to the one or more personal health modulating data processing routines to an analyst machine connected with the network.

11. A personal health modulating method comprising:
receiving, by at least one electronic data input of a mobile computing device, data representing one or more attributes related to an activity of a user, the data being sensed and gathered from an environment that is external to the mobile computing device by at least one sensor, the mobile computing device further comprising, at least one wireless transceiver for communicating with a wireless network, an interactive display, and an internal processor;
receiving, by the internal processor of the mobile computing device, the data representing the one or more attributes related to the activity;
processing, by the internal processor of the mobile computing device, the data according to one or more personal health modulating data processing routines; and
generating a graphical user interface for display on the interactive display of the mobile computing device, the graphical user interface providing a representation of at least one of the one or more personal health modulating data processing routines.

12. The method in accordance with claim 11, wherein the at least one sensor is a scale that is configured to weigh food for consumption by the user.

13. The method in accordance with claim 12, wherein the scale is adapted for fitting under a plate that holds the food.

14. The method in accordance with claim 11, wherein the at least one sensor is a machine-readable code reader that is configured to read a code associated with a package of food for consumption by the user.

15. The method in accordance with claim 11, wherein the at least one sensor is a camera that is configured to acquire a digital image of food for consumption by the user.

16. The method in accordance with claim 15, wherein the camera is integrated with the mobile computing device.

17. The method in accordance with claim 15, wherein the camera is external to the mobile computing device.

18. The method in accordance with claim 11, wherein the at least one sensor is a sleep sensor to be worn on or near the user for measuring sleep patterns of the user.

19. The method in accordance with claim 18, wherein the sleep sensor is integrated with a wrist band.

20. The method in accordance with claim 11, wherein the application executed on the internal processor is further configured to transmit, via the wireless network by the at least one wireless transceiver of the mobile computing device, the data processed according to the one or more personal health modulating data processing routines to an analyst machine connected with the network.

21. A personal health modulating device for communicating health modulating data with a mobile computing device, the mobile computing device having at least one electronic data input for receiving electronic data, at least one wireless transceiver for communicating with a wireless network, and an interactive display, the personal health modulating device comprising:
a wearable unit configured to be worn on a part of a user's body, the wearable unit having one or more sensors to sense an environment of the user, to gather data representing one or more attributes related to an activity of a user within the environment, the data being selected for processing according to one or more personal health modulating data processing routines, the wearable unit further having a transmitter to transmit the data to the at least one electronic data input of the mobile computing device.

22. The device in accordance with claim 21, wherein the wearable unit is a bracelet.

23. The device in accordance with claim 21, wherein the wearable unit includes eyewear frames.

24. The device in accordance with claim 21, wherein the wearable unit is a ring.

25. The device in accordance with claim 21, wherein the one or more sensors are adapted to sense a physical activity by the user.

26. The device in accordance with claim 21, wherein the one or more sensors are adapted to sense a food for consumption by the user, and wherein the one or more attributes include a content of at least part of the food.

27. The device in accordance with claim 26, wherein the content of at least part of the food includes an alcohol content of the food.

28. The device in accordance with claim 26, wherein the content of at least part of the food includes a caloric content of the food.

29. The device in accordance with claim 21, wherein the one or more sensors are adapted to sense a physical activity of the user, and wherein the one or more attributes include a number of movements of a user's body.

30. The device in accordance with claim 21, further comprising a display connected with the wearable unit, the display for displaying at least part of the data.
